(19) United States
(12) Patent Application Publication
(10) Pub. No.: US 2005/0160674 A1
(43) Pub. Date: Jul. 28, 2005

(54) Automatic opening and closing system for vehicle

(75) Inventors: Yasunori Noro, Kiryu-shi (JP); Yoshio Matsushima, Kiryu-shi (JP); Wataru Suzuki, Kiryu-shi (JP)

Correspondence Address: MCCORMICK, PAULDING & HUBER LLP, CITY PLACE II, 185 ASYLUM STREET, HARTFORD, CT, 06103, US

(73) Assignee: Mitsuba Corporation, Kiryu-shi (JP)

(21) Appl. No.: 11/039,222

(22) Filed: Jan. 20, 2005

(30) Foreign Application Priority Data
Jan. 22, 2004 (JP) 2004-014635

(51) Int. Cl. E05F 11/00

(52) U.S. Cl. 49/360

(57) ABSTRACT

The reduction of cost, size, and weight of an automatic opening and closing system for a vehicle provided with an electromagnetic clutch is achieved. An electromagnetic clutch is provided between a worm gear mechanism in a drive unit and an output shaft connected to a slide door. The electromagnetic clutch has a clutch coil fixed to inside of a worm wheel and an armature attached to the output shaft so as to be movable in the axial direction. Coil ends of the clutch coil are electrically connected to slip rings fixed to the worm wheel, and contacts connected to an electric power source are slidably brought into contact with the slip rings, and electric power is supplied to the clutch coil through these components. By magnetic attraction force generated by the clutch coil in a conducting state, the armature is attracted and engaged with the worm wheel.

### CROSS-REFERENCE TO RELATED APPLICATION

The present application claims priority from Japanese Patent Application JP 2004-014635 filed on Jan. 22, 2004, the content of which is hereby incorporated by reference into this application.

### TECHNICAL FIELD OF THE INVENTION

The present invention relates to an automatic opening and closing system for a vehicle which automatically opens and closes an opening and closing member provided in a vehicle. More particularly, it relates to an automatic opening and closing system provided with an electromagnetic clutch which shuts off power transmission between an electric motor and the opening and closing member when the opening and closing member is operated by hand.

### BACKGROUND OF THE INVENTION

In a vehicle such as an automobile, opening and closing members such as a door, a back door, and a sunroof are provided in various parts thereof. Particularly, in many vans, station wagons and the like, a slide door that can be opened and closed in a back-and-forth direction of a vehicle is provided on the side of the vehicle so as to make it easier for people to get on and off and to load or unload baggage from the side of the vehicle.

Since the open space by the side of a vehicle required when opening or closing such a slide door is small, such a slide door is often employed for a comparatively large opening. Therefore, the slide door itself tends to be large and the weight of the slide door is increased, and as a result, it is sometimes difficult for women and children to easily open and close the door. Particularly, the slide door cannot be easily opened on a slope due to its own weight, for example. For its solution, under the circumstance in which automobiles for family use such as a station wagon are so popular, a vehicle equipped with an automatic opening and closing system for a vehicle for automatically opening and closing a slide door has been developed so that even women and children can easily open and close the door.

The system is known as such an automatic opening and closing system, in which cables connected to a slide door from the front side and the rear side of the vehicle are wound around a drum disposed inside a side panel of the vehicle, and the slide door is opened or closed by driving and rotating the drum by a drive unit. In this case, the drive unit has a structure in which an electric motor serving as a drive source and a worm gear mechanism housed in a gear case are integrated into a unit, and the rotation of the electric motor is reduced to a predetermined rotation speed by the worm gear mechanism and then outputted through an output shaft. An end of the output shaft is protruding from the gear case, and the above-described drum is fixed to the end of the output shaft so as to be driven and rotated by the drive unit. Therefore, when the electric motor is actuated, either one of the cables, i.e., that of the front side or the rear side of the vehicle is reeled onto the drum and the slide door is drawn by the cable to be opened or closed. Note that the movement direction is determined according to the rotation direction of the electric motor.

Meanwhile, even in a vehicle in which such an automatic opening and closing system is provided, the slide door is opened or closed by hand in some cases. However, since the slide door is connected to the electric motor via the cables, the drum, the worm gear mechanism, etc., a larger force is required to operate the slide door in comparison to that required to operate a slide door not having the automatic opening and closing system. For its solution, the system is known, in which an electromagnetic clutch is provided between the worm gear mechanism and the output shaft, and the electromagnetic clutch is in a shut-off state when the slide door is opened or closed by hand. Accordingly, when the door is opened or closed by hand, power transmission between the electric motor and the slide door is shut off by the electromagnetic clutch, and as a result, the force required to open and close the door is reduced to the same level as a general slide door not having the automatic opening and closing system, and the operational ease can be improved.

As such an electromagnetic clutch, those described in Japanese Patent Application Laid-Open No. 62-22008 and Japanese Patent Application Laid-Open No. 2000-177391 are known, which are provided with a rotor rotated cooperatively with a worm wheel constituting a worm gear mechanism, an armature rotated together with an output shaft, and a clutch coil fixed to a gear case. In this case, the clutch coil is fixed to the gear case in a state of being wound around a clutch yoke, and magnetic attraction force is generated when electric power is supplied from a power source. Meanwhile, the rotor and the armature plate are housed in the gear case so as to be rotatable by bearings provided in the space between them and the output shaft or the clutch yoke, respectively. Therefore, they are relatively rotatable with each other when the clutch coil is in a non-conducting state. When electricity is applied to the clutch coil, the rotor and the armature are pressed and joined by the magnetic attraction force generated by the clutch coil, and the rotation of the worm wheel is transmitted to the output shaft. Also, the power transmission state and shut-off state of the electromagnetic clutch are switched by controlling the power supply to the clutch coil.

### SUMMARY OF THE INVENTION

However, in such an electromagnetic clutch, while the rotor and the armature are rotated together with the worm wheel and the output shaft in the gear case, the clutch coil is fixed to the gear case. Accordingly, in addition to the bearings for rotatably supporting the rotor and the output shaft to the gear case, a bearing has to be provided between the clutch coil and the rotor or the output shaft. Therefore, the number of components of the electromagnetic clutch is increased, and the cost of the automatic opening and closing system is increased.

Meanwhile, when the rotor and the output shaft are supported by bearings provided in the space between them and the clutch yoke, the space is widened by the size of the bearings, and the outer diameter of the electromagnetic clutch is increased. Also, since the rotor, the armature, and the clutch coil are generally disposed so as to be overlapped in the axial direction, the size of the electromagnetic clutch is enlarged in the axial direction. Therefore, the size of the electromagnetic clutch is enlarged, which prevents the reduction of the size and the weight of the automatic opening and closing system.

An object of the present invention is to reduce the cost of an automatic opening and closing system for a vehicle which is provided with an electromagnetic clutch.

Another object of the present invention is to reduce the size and weight of an automatic opening and closing system for a vehicle which is provided with an electromagnetic clutch.

An automatic opening and closing system for a vehicle according to the present invention is an automatic opening and closing system for a vehicle for automatically opening and closing an opening and closing member provided in the vehicle, and the automatic opening and closing system for a vehicle comprises: an electric motor provided with a rotating shaft; an output shaft connected to the opening and closing member; a worm gear mechanism provided with a worm and a worm wheel for reducing the rotation speed of the rotating shaft and outputting the rotation; a gear case for housing the worm gear mechanism; an armature formed of a magnetic substance and attached to the output shaft so as to be rotated together with the output shaft; a clutch coil fixed to the worm wheel for generating magnetic attraction force for causing the armature plate to be engaged with the worm wheel; and an electric power supply unit for supplying electric power to the clutch coil.

The automatic opening and closing system for a vehicle according to the present invention is characterized in that the electric power supply unit comprises a pair of first electrodes electrically connected to coil ends of the clutch coil and fixed to the worm wheel, and a pair of second electrodes connected to an electric power source and fixed to the gear case so as to be slidably brought into contact with the first electrodes.

The automatic opening and closing system for a vehicle according to the present invention is characterized in that the first electrodes comprise a pair of slip rings formed in a circular ring shape by a conductor and concentrically disposed around the output shaft serving as an axis, and the second electrodes comprise a pair of contacts brought into contact with the slip rings corresponding thereto.

The automatic opening and closing system for a vehicle according to the present invention is characterized in that the contacts are elastically brought into contact with the slip rings.

The automatic opening and closing system for a vehicle according to the present invention is characterized in that a force is applied to the contacts by an elastic member in the direction toward the slip rings.

The automatic opening and closing system for a vehicle according to the present invention is characterized in that the contacts are formed so as to be elastically deformable with respect to the slip rings.

The automatic opening and closing system for a vehicle according to the present invention is characterized in that the clutch coil is accommodated in a clutch yoke fixed to the worm wheel.

The automatic opening and closing system for a vehicle according to the present invention is characterized in that the clutch coil is disposed inside the worm wheel.

The automatic opening and closing system for a vehicle according to the present invention is characterized in that the worm wheel and the armature have cogs which are meshed with each other for engaging the worm wheel and the armature.

The automatic opening and closing system for a vehicle according to the present invention is characterized in that the armature is attached to the output shaft so as to be movable in the axial direction of the output shaft, and a force is applied to the armature in a direction away from the worm wheel by a plate spring member supported by the output shaft.

The automatic opening and closing system for a vehicle according to the present invention is characterized in that the clutch coil is accommodated in a clutch yoke which is fixed to the worm wheel.

The automatic opening and closing system for a vehicle according to the present invention is characterized in that the clutch coil is disposed inside the worm wheel.

The automatic opening and closing system for a vehicle according to the present invention is characterized in that the worm wheel and the armature have cogs which are meshed with each other for engaging the worm wheel and the armature.

The automatic opening and closing system for a vehicle according to the present invention is characterized in that the armature is attached to the output shaft so as to be movable in the axial direction of the output shaft, and a force is applied to the armature in a direction away from the worm wheel by a plate spring member supported by the output shaft.

According to the present invention, since the clutch coil is fixed to the worm wheel and rotated together with the worm wheel, a bearing for supporting the clutch coil so as to be relatively rotatable with respect to rotating members such as the armature, the output shaft, and the worm wheel is not required. In addition, since power is transmitted by the engaged worm wheel and armature, it is unnecessary to additionally provide a rotor or the like to be engaged with the armature. Therefore, the number of components of the electromagnetic clutch is reduced, and the cost of the automatic opening and closing system for a vehicle can be reduced.

In addition, according to the present invention, since the bearing for supporting the clutch coil so as to be relatively rotatable with respect to rotating members such as the armature, the output shaft, and the worm wheel is not required, the size and the weight of the electromagnetic clutch is accordingly reduced, and the size and the weight of the automatic opening and closing system for a vehicle can be reduced.

Furthermore, according to the present invention, since the clutch coil is fixed to the inside of the worm wheel, the thickness of the electromagnetic clutch in the axial direction can be reduced. Therefore, the size and the weight of the electromagnetic clutch can be reduced, and the size and the weight of the automatic opening and closing system for a vehicle can be reduced.

Furthermore, according to the present invention, since cogs are provided in the worm wheel and the armature and the worm wheel and the armature are engaged by the cogs, desired power can be transmitted even when the outer diameter of the worm wheel and the armature is reduced. Therefore, the size and the weight of the electromagnetic clutch are reduced, and the size and the weight of the automatic opening and closing system for a vehicle can be reduced.

### BRIEF DESCRIPTIONS OF THE DRAWINGS

FIG. 1 is an explanatory drawing showing a vehicle equipped with an automatic opening and closing system for a vehicle according to an embodiment of the present invention;

FIG. 2 is an enlarged plan view showing a principal part of the vehicle shown in FIG. 1;

FIG. 3 is a cross sectional view showing the details of the drive unit shown in FIG. 2;

FIG. 4A is a cross sectional view showing the engagement part of a worm wheel and an armature shown in FIG. 3;

FIG. 4B is a cross sectional view showing a state where cogs shown in FIG. 4A are meshed with each other; and

FIG. 5 is a perspective view showing the details of an electric power supply unit shown in FIG. 3.

### DESCRIPTIONS OF THE PREFERRED EMBODIMENTS

Hereinafter, an embodiment of the present invention will be described in detail with reference to the accompanying drawings.

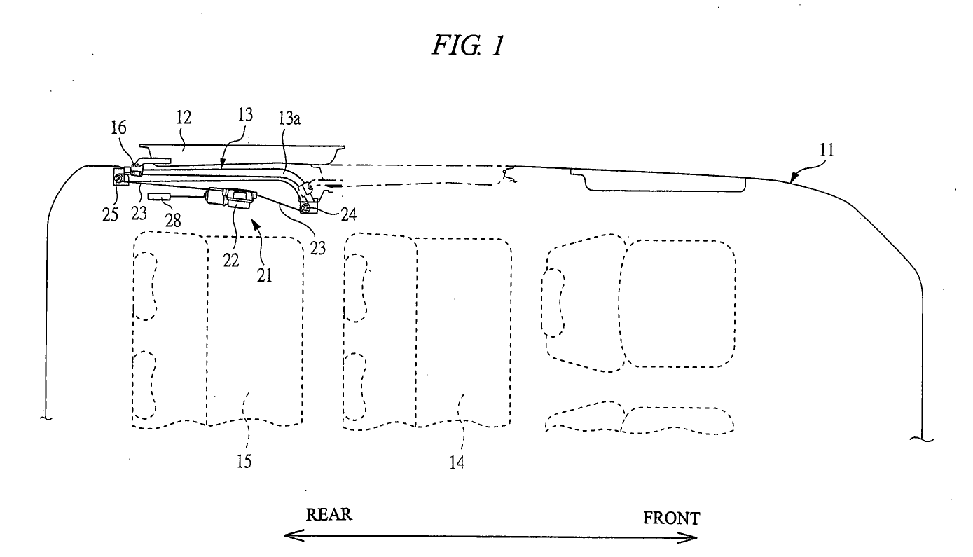

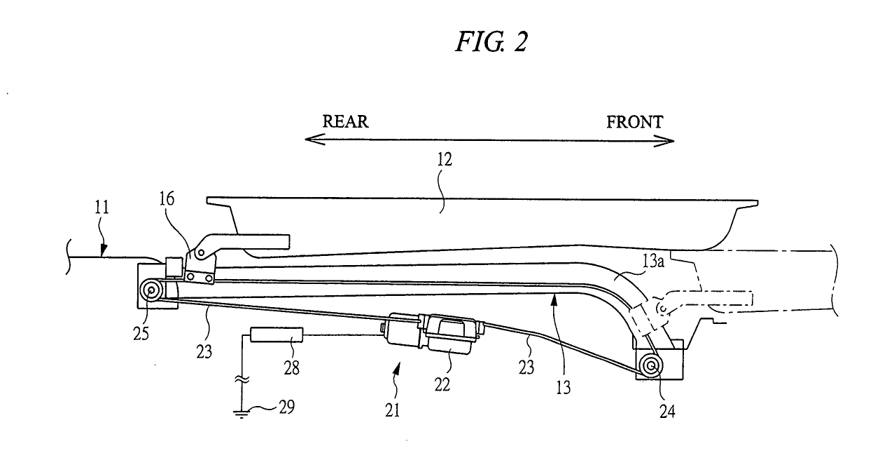

FIG. 1 is an explanatory drawing showing a vehicle equipped with an automatic opening and closing system for a vehicle which is an embodiment of the present invention, and FIG. 2 is an enlarged plan view showing a principal part of the vehicle shown in FIG. 1.

A slide door 12 serving as an opening and closing member is provided on the side of a vehicle 11 shown in FIG. 1. The slide door 12 is guided by a guide rail 13 fixed to the vehicle 11 so that it can be opened and closed between a full open position represented by a solid line and a full close position represented by a chain line in the drawing. For example, when a passenger is to get on or off or baggage is to be loaded or unloaded to/from a second seat 14 or a third seat 15 provided in the interior of the vehicle, the slide door is opened to the full open position.

As shown in FIG. 2, a roller assembly 16 is attached to the slide door 12, and the roller assembly 16 is guided by the guide rail 13 so as to make the slide door 12 movable in an back-and-forth direction of the vehicle. Also, a curved portion 13a curved toward the interior of the vehicle is provided in the guide rail 13 at the part near the front side of the vehicle. The roller assembly 16 is guided by the curved portion 13a so that the slide door 12 is pulled into the vehicle 11 and closed so as to fit within the same surface as the side surface of the vehicle 11.

An automatic opening and closing system 21 for a vehicle (hereinafter, referred to as an automatic opening and closing system 21) is provided in the vehicle 11 for automatically opening and closing the slide door 12. The automatic opening and closing system 21 is provided with a drive unit 22 positioned adjacent to the approximate center of the guide rail 13 in the back-and-forth direction of the vehicle and fixed in the side panel of the vehicle 11, and two cables 23 for connecting the slide door 12 with the drive unit 22. The cables 23 are connected to the slide door 12 via the roller assembly 16 from the front side and the rear side of the vehicle, respectively. In addition, reversing pulleys 24 and 25 are provided at the ends of the guide rail 13, i.e. the ends near the front side and rear side of the vehicle, and the cables 23 are guided into the drive unit 22 via the reversing pulleys 24 and 25. When either one of the cables 23 is pulled by the drive unit 22, the slide door 12 is opened or closed.

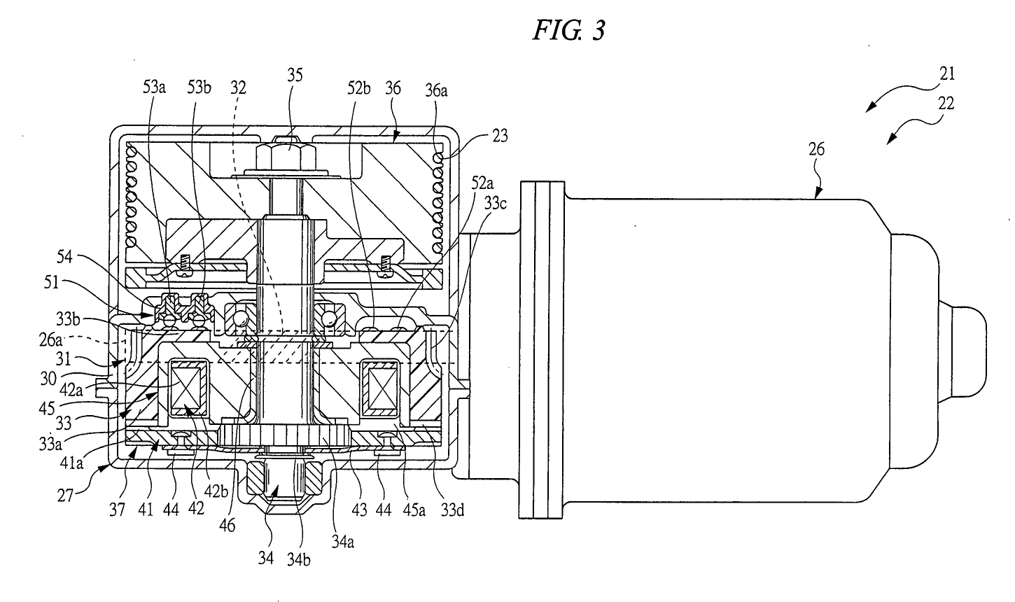

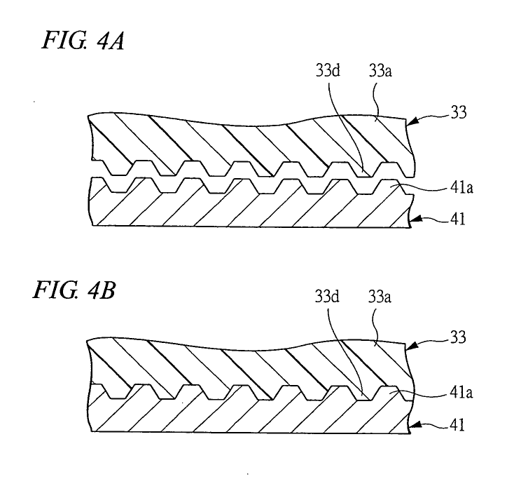

FIG. 3 is a cross sectional view showing the details of the drive unit shown in FIG. 2, FIG. 4A is a cross sectional view showing the engagement part of a worm wheel and an armature shown in FIG. 3, and FIG. 4B is a cross sectional view showing a state where cogs shown in FIG. 4A mesh with each other.

As shown in FIG. 3, the drive unit 22 is provided with an electric motor 26 having a rotating shaft 26a and a reduction gear 27 fixed to the electric motor 26. In this case, a so-called direct current motor with brush which can rotate the rotating shaft 26a in either forward or reverse direction is employed as the electric motor 26, and a control unit 28 controls the operation of the motor.

The control unit 28 has a function as a so-called microcomputer which is provided with a CPU, a memory, etc., and is connected to an electric power source 29 such as a battery equipped on the vehicle 11 as shown in FIG. 2 and a slide door opening and closing switch (not shown). The control unit 28 supplies a direct current in a predetermined direction from the electric power source 29 to the electric motor 26 in response to a command signal sent from the slide door opening and closing switch.

In this embodiment, a direct current motor with brush is employed as the electric motor 26. However, the motor is not limited to this, and a different electric motor such as a brushless motor may be employed.

The reduction gear 27 has a structure in which a worm gear mechanism 31 is housed in a gear case 30 which is fixed to the electric motor 26. The worm gear mechanism 31 has a worm 32 and a worm wheel 33, and in the illustrated case, the worm 32 is integrally formed with the outer periphery of the rotating shaft 26a of the electric motor 26. Meanwhile, the worm wheel 33 has a bottomed-cylindrical shape in which a cylindrical portion 33a and a bottom-wall portion 33b are integrally formed by a resin material, and the worm wheel is meshed with the worm 32 at a gear portion 33c provided on the outer peripheral surface of the cylindrical portion 33a. Therefore, rotation of the rotating shaft 26a is reduced to a predetermined rotation speed and then outputted from the worm wheel 33.

Also, the reduction gear 27 is provided with an output shaft 34 which is rotatably supported by two bearings provided in the gear case 30. One end of the output shaft 34 is protruding from the gear case 30, and a drum 36 which is an output member is fixed to the end by a nut 35. The drum 36 is made of resin and two cable guide grooves 36a are spirally formed on the outer peripheral surface thereof, and each of the cables 23 guided into the drive unit 22 is wound a plurality of times around the corresponding cable guide groove 36a of the drum 36 in a direction opposite to each other. That is, the output shaft 34 is connected to the slide door 12 via the drum 36 and the cables 23.

Although not illustrated, a tensioner mechanism for maintaining the tension force of the cables 23 within a predetermined range may be provided between the drum 36 and the slide door 12.

An electromagnetic clutch 37 is provided between the worm gear mechanism 31 and the output shaft 34, and the power transmission between the worm wheel 33 and the output shaft 34 can be controlled by the electromagnetic clutch 37. The details of the electromagnetic clutch 37 will be described later.

In the structure as described above, when the electric motor 26 is actuated, the rotation of the rotation shaft 26a thereof is transmitted to the output shaft 34, i.e. the drum 36 via the worm gear mechanism 31 and the electromagnetic clutch 37, and either one of the cables 23 is reeled onto the drum 36, thereby opening or closing the slide door 12. The direction for opening or closing the slide door 12 is determined by the rotation direction of the electric motor 26, i.e. the rotation direction of the drum 36.

Next, the structure of the electromagnetic clutch 37 will be described.

The electromagnetic clutch 37 is provided with an armature 41 which is attached to the output shaft 34 and rotates together with the output shaft 34, and a clutch coil 42 fixed to the worm wheel 33 and generating magnetic attraction force for engaging the armature 41 with the worm wheel 33.

The armature 41 is formed of a magnetic substance such as a steel material, has a disk-like shape, and is attached to the output shaft 34 at the axis thereof. A serration portion 34a is formed in the output shaft 34, and the armature 41 engages with the serration portion 34a so as to rotate together with the output shaft 34. Also, the armature 41 is movable in the axial direction of the output shaft 34.

A plate spring member 43 is provided between the armature 41 and the output shaft 34. The plate spring member 43 is formed in a shape of a cone frustum, and is fixed to the output shaft 34 at the inner circumferential side thereof by a snap ring 34b and fixed to the armature 41 at the outer circumferential side thereof by a rivet 44, thereby steadily applying a force to the armature 41 in the direction away from the worm wheel 33.

Meanwhile, a clutch yoke 45 formed in a circular ring shape by a magnetic substance such as a steel material is fixed onto the inside of the worm wheel 33, and a clutch coil 42 is attached to the inside of an accommodation groove 45a formed in the clutch yoke 45 in a state where a coil wire 42a is wound around a coil bobbin 42b. That is, in the illustrated case, the clutch yoke 45 is fixed by fixation means (not shown) in a state where the outer peripheral surface of the clutch yoke 45 is fit onto the inner surface of the cylindrical portion 33a of the worm wheel 33 and one end of the clutch yoke 45 in the axial direction is accommodated in the space inside the worm wheel 33 so as to abut against the bottom wall portion 33b. Therefore, the clutch coil 42 attached to the inside of the clutch yoke 45 is fixed to the worm wheel 33 in a state where it is disposed inside the worm wheel 33. Also, the clutch yoke 45 is supported so as to be relatively rotatable with respect to the output shaft 34 via a plain bearing 46. Accordingly, the worm wheel 33 and the clutch coil 42 are relatively rotatable with respect to the output shaft 34. Therefore, when the worm wheel 33 is rotated, the clutch coil 42 is rotated together with the worm wheel 33 and the clutch yoke 45.

As shown in FIG. 4A, a plurality of cogs 41a protruding toward the worm wheel 33 are formed on the side of the outer peripheral end of the armature 41 so as to be arranged in the circumferential direction, and cogs 33d corresponding to the cogs 41a are formed on the side of the outer peripheral end of the worm wheel 33 so as to be arranged in the circumferential direction. As shown in FIG. 4B, the cogs 41a and 33d are mutually meshed when the armature 41 moves in the direction toward the worm wheel 33, and accordingly, the armature 41 and the worm wheel 33 are engaged and the worm wheel 33 and the armature 41 are integrally rotated. That is, the electromagnetic clutch 37 is a so-called mesh type in which power is transmitted when the cogs 41a and 33d formed on the armature 41 and the worm wheel 33 are meshed.

In the illustrated case, the electromagnetic clutch 37 is a so-called mesh type in which cogs 41a and 33d are formed on the armature 41 and the worm wheel 33. However, the electromagnetic clutch may be a friction type in which friction surfaces which are mutually jointed by friction are provided on the worm wheel 33 and the armature 41.

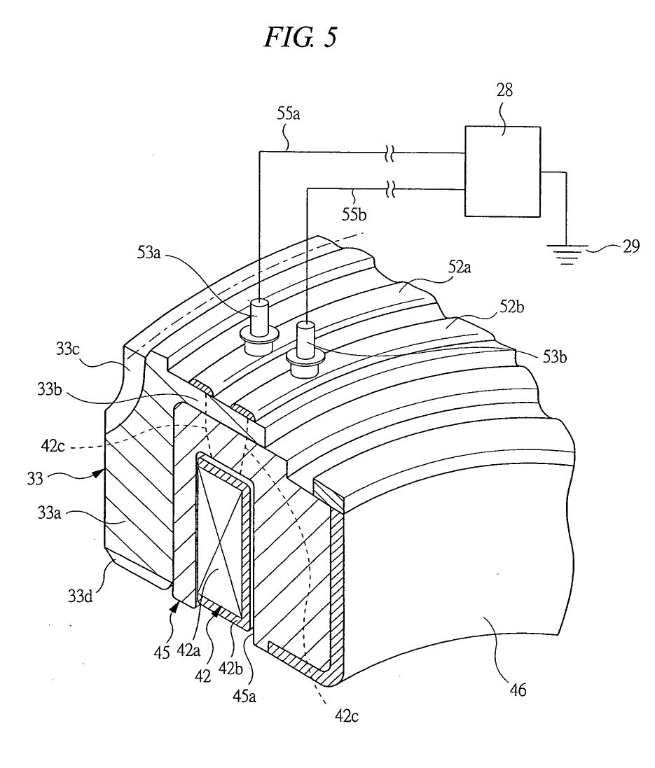

FIG. 5 is a perspective view showing the details of an electric power supply unit shown in FIG. 3. An electric power supply unit 51 is provided in the electromagnetic clutch 37 in order to supply electric power to the clutch coil 42 which rotates together with the worm wheel 33. The electric power supply unit 51 is provided with a pair of slip rings 52a and 52b serving as first electrodes which are fixed on the bottom wall portion 33b of the worm wheel 33, and a pair of contacts 53a and 53b serving as second electrodes which are attached to the gear case 30 side and slidably abutting against the corresponding slip rings 52a and 52b, respectively.

The slip rings 52a and 52b are formed into a circular ring shape by a conductor such as a copper plate. One of the slip rings, that is, the slip ring 52b is formed to have a diameter smaller than the other slip ring, that is, the slip ring 52a and is disposed inside the slip ring 52a so as to be away from the slip ring 52a. In other words, these slip rings 52a and 52b are concentrically disposed around the output shaft 34 serving as their axis. Also, one coil end 42c of the clutch coil 42 is electrically connected to the slip ring 52a, and the other coil end 42c of the clutch coil 42 is electrically connected to the slip ring 52b.

Meanwhile, as shown in FIG. 3, the contacts 53a and 53b are supported by a holder 54 which is attached to the gear case 30, and are brought into contact with the slip rings 52a and 52b along the axial direction parallel to the output shaft 34. Note that it is also preferable that the contacts 53a and 53b are arranged so as to be elastically brought into contact with the slip rings 52a and 52b. For example, elastic members such as springs for applying a force to the contacts 53a and 53b in the direction toward the slip rings 52a and 52b may be attached to the holder 54, or the contacts 53a and 53b may be formed to be elastically deformable with respect to the slip rings 52a and 52b.

Each of the contacts 53a and 53b is connected to the control unit 28 via electric power supply lines 55a and 55b, and electric power of the electric power source 29 is supplied via the control unit 28. When electric power is supplied from the electric power source 29 to the contacts 53a and 53b by the control unit 28, the electric power is supplied to the clutch coil 42 via the slip rings 52a and 52b.

As described above, in the automatic opening and closing system 21, electric power supply to the clutch coil 42 is carried out by the electric power supply unit 51 using the slip rings 52a and 52b and contacts 53a and 53b, thereby enabling the structure in which the clutch coil 42 is fixed to the worm wheel 33 and rotated together with the worm wheel 33.

Next, actuation of the electromagnetic clutch 37 will be described.

First, when the slide door opening and closing switch (not shown) is operated to actuate the electric motor 26, electric power is supplied from the control unit 28 to the clutch coil 42. When electric power is supplied to the clutch coil 42 and the clutch coil 42 is in an conducting state, a magnetic field is generated and the magnetic attraction force is generated in the clutch yoke 45 by the magnetic field. Then, by the magnetic attraction force, the armature 41 is attracted to the clutch yoke 45 and moved in the direction toward the worm wheel 33. As a result, the cogs 33d of the worm wheel 33 and the cogs 41a of the armature 41 are meshed so that the worm wheel 33 and the armature 41 are engaged with each other. In this manner, the power is transmitted between the worm wheel 33 and the armature 41. In other words, when the clutch coil 42 is in an conducting state, the electromagnetic clutch 37 is in a power transmission state in which the worm wheel 33 and the armature 41 are engaged. As a result, the rotation of the rotating shaft 26a is transmitted to the drum 36 via the worm gear mechanism 31, the electromagnetic clutch 37, and the output shaft 34, and the cable 23 is reeled onto the drum 36. In this manner, an automatic opening or closing operation of the slide door 12 is performed.

On the contrary, when the slide door 12 is to be operated by hand, electric power supply to the clutch coil 42 is stopped by the control unit 28. When the clutch coil 42 is in a non-conducting state, the magnetic attraction force by the clutch coil 42 disappears and the armature 41 moves in the direction away from the worm wheel 33 by the elastic force of the plate spring member 43. As a result, the engagement between the worm wheel 33 and the armature 41 is released, and the electromagnetic clutch 37 is in a power off state. Therefore, when the slide door 12 is opened or closed by hand, the worm wheel 33, the worm 32, and the rotating shaft 26 are not rotated, and the force required for operating the slide door 12 is reduced, thereby improving the operational ease. As described above, by controlling the electric power supply to the clutch coil 42 by the control unit 28, power transmission between the worm wheel 33 and the armature 41 can be controlled.

The control of electric power supply to the clutch coil 42 by the control unit 28 is performed in accordance with a control map stored in a memory of the control unit 28.

As described above, in the automatic opening and closing system 21, the clutch coil 42 is fixed to the worm wheel 33 and rotated together with the worm wheel 33, and electric power supply to the clutch coil 42 is performed by the electric power supply unit 51 which is fixed to the worm wheel 33 and is provided with the slip rings 52a and 52b electrically connected to the coil ends 42c of the clutch coil 42 and the contacts 53a and 53b connected to the electric power source 29. Accordingly, the clutch coil 42 and the worm wheel 33 can be supported by the same plain bearing 46 so as to be rotatable with respect to the output shaft 34. As a result, a bearing for exclusively supporting the clutch coil 42 so as to be relatively rotatable with respect to rotating members such as the armature 41 and the output shaft 34 becomes unnecessary. Therefore, the number of components of the electromagnetic clutch 37 is reduced, and the cost of the automatic opening and closing system 21 can be reduced.

In addition, since the electromagnetic clutch 37 is in the power transmission state when the worm wheel 33 and the armature 41 are engaged, it is not necessary to additionally provide a rotor or the like for power transmission between the armature 41 and the worm wheel 33. Therefore, the number of components of the electromagnetic clutch 37 is reduced, and the cost of the automatic opening and closing system 21 can be further reduced.

In addition, since a bearing for supporting the clutch coil 42 so as to make it relatively rotatable with respect to rotating members such as the armature 41, the output shaft 34, and the worm wheel 33 is not required in the automatic opening and closing system 21, the size and the weight of the electromagnetic clutch 37 is accordingly reduced, and the size and the weight of the automatic opening and closing system 21 can be further reduced.

Furthermore, since the clutch coil 42 is fixed to the inside of the worm wheel 33 in the automatic opening and closing system 21, the thickness of the electromagnetic clutch 37 in the axial direction can be reduced. Furthermore, since the cogs 33d and 41a are provided in the worm wheel 33 and the armature 41 and the worm wheel 33 and the armature 41 are engaged when the cogs 33d and 41a are meshed, desired power can be transmitted even when the outer diameter of the worm wheel 33 and the armature 41 are reduced. Therefore, the size and the weight of the electromagnetic clutch 37, i.e. those of the automatic opening and closing system 21 can be reduced. In addition, by reducing the size of the automatic opening and closing system 21, the thickness of the side panel can be reduced so as to enlarge the interior of the vehicle in the case where the automatic opening and closing system 21 is loaded in the side panel of the vehicle 11.

It is needless to say that the present invention is not limited to the foregoing embodiment and various modifications and alterations can be made within the scope of the present invention. For example, in the above-described embodiment, the opening and closing member is the slide door 12 which is slidably opened and closed, however, the member is not limited to this and a different opening and closing member such as a side-open door used for a passenger to get on and off or a back door may be employed.

Also, in the embodiment described above, the slide door 12 is actuated by reeling in the cable 23 which is connected to the slide door 12 by the drum 36 which is fixed to the output shaft 34. However, the structure is not limited to this and any other structures are available as long as the opening and closing member is opened or closed by the rotation of the output shaft 34. For example, the following structures are available, that is: a pinion gear is fixed to the output shaft 34 so as to drive a rack connected to the opening and closing member by the pinion gear, or an arm connected to the opening and closing member is fixed to the output shaft 34.

Furthermore, in the embodiment described above, the drive unit 22 is fixed to the inside of the side panel of the vehicle 11. However, the attachment position is not limited to this, and the drive unit may be fixed to the inside of the roof of the vehicle 11 when driving a back door for opening and closing the rear end part of the vehicle 11.

Furthermore, in the embodiment described above, the slip rings 52a and 52b are attached to the worm wheel 33 side and the contacts 53a and 53b are attached to the gear case 30 side. However, the structure is not limited to this, and the contacts 53a and 53b may be attached to the worm wheel 33 side and the slip rings 52a and 52b may be attached to the gear case 30 side.

1. An automatic opening and closing system for a vehicle for automatically opening and closing an opening and closing member provided in the vehicle, the automatic opening and closing system for a vehicle comprising:
an electric motor provided with a rotating shaft;
an output shaft connected to said opening and closing member;
a worm gear mechanism provided with a worm and a worm wheel for reducing the rotation speed of said rotating shaft and outputting the rotation;
a gear case for housing said worm gear mechanism;
an armature formed of a magnetic substance and attached to said output shaft so as to be rotated together with said output shaft;
a clutch coil fixed to said worm wheel for generating magnetic attraction force for causing said armature plate to be engaged with said worm wheel; and
an electric power supply unit for supplying electric power to said clutch coil.

2. The automatic opening and closing system for a vehicle according to claim 1,
wherein said electric power supply unit comprises a pair of first electrodes electrically connected to coil ends of said clutch coil and fixed to said worm wheel, and a pair of second electrodes connected to an electric power source and fixed to said gear case so as to be slidably brought into contact with said first electrodes.

3. The automatic opening and closing system for a vehicle according to claim 2,
wherein said first electrodes comprise a pair of slip rings formed in a circular ring shape by a conductor and concentrically disposed around said output shaft serving as an axis, and said second electrodes comprise a pair of contacts brought into contact with said slip rings corresponding thereto.

4. The automatic opening and closing system for a vehicle according to claim 3,
wherein said contacts are elastically brought into contact with said slip rings.

5. The automatic opening and closing system for a vehicle according to claim 4,
wherein a force is applied to said contacts by an elastic member in the direction toward said slip rings.

6. The automatic opening and closing system for a vehicle according to claim 4,
wherein said contacts are formed so as to be elastically deformable with respect to said slip rings.

7. The automatic opening and closing system for a vehicle according to claim 1,
wherein said clutch coil is accommodated in a clutch yoke fixed to said worm wheel.

8. The automatic opening and closing system for a vehicle according to claim 1,
wherein said clutch coil is disposed inside said worm wheel.

9. The automatic opening and closing system for a vehicle according to claim 1,
wherein said worm wheel and said armature have cogs which are meshed with each other for engaging said worm wheel and said armature.

10. The automatic opening and closing system for a vehicle according to claim 1,
wherein said armature is attached to said output shaft so as to be movable in the axial direction of said output shaft, and a force is applied to said armature in a direction away from said worm wheel by a plate spring member supported by said output shaft.

11. The automatic opening and closing system for a vehicle according to claim 2,
wherein said clutch coil is accommodated in a clutch yoke which is fixed to said worm wheel.

12. The automatic opening and closing system for a vehicle according to claim 2,
wherein said clutch coil is disposed inside said worm wheel.

13. The automatic opening and closing system for a vehicle according to claim 2,
wherein said worm wheel and said armature have cogs which are meshed with each other for engaging said worm wheel and said armature.

14. The automatic opening and closing system for a vehicle according to claim 2,
wherein said armature is attached to said output shaft so as to be movable in the axial direction of said output shaft, and a force is applied to said armature in a direction away from said worm wheel by a plate spring member supported by said output shaft.
